(19) United States
(12) Patent Application Publication
(10) Pub. No.: US 2026/0221667 A1
(43) Pub. Date: Jul. 30, 2026

(54) RADIATION UNIT

(71) Applicant: BEA SA, Angleur (BE)

(72) Inventors: Vincent KASCHTEN, Angleur (BE); Christophe CRAEYE, Mont-Saint-Guibert (BE); Dimitri LEDERER, Court-Saint-Etienne (BE); Alain Louis ZAMBON, Saint-Nicolas (BE)

(73) Assignee: BEA SA, Angleur (BE)

(21) Appl. No.: 19/150,347

(22) PCT Filed: Jan. 26, 2024
(86) PCT No.: PCT/EP2024/051917

§ 371 Date: Jul. 23, 2025

(30) Foreign Application Priority Data
Jan. 27, 2023 (DE) 10 2023 102 085.4

(51) Int. Cl. H01Q 15/08; H01Q 19/06

(52) U.S. Cl. CPC H01Q 15/08; H01Q 19/062

(57) ABSTRACT

The invention refers to a radiation unit comprising a lens (10) having a dielectric refractive lens body (12) that transfers electromagnetic waves. The invention is characterized in that the dielectric refractive lens body (12) has a first relative permittivity ε_{centre} the center and a second relative permittivity ε_{peripheral edge} in the edge region of the lens, where the first relative permittivity ε_{centre} and the second relative permittivity ε_{peripheral edge} are related by the relation ε_{centre}=1.42 √ε_{peripheral edge}+0.58, with a tolerance of 0.2, where |ε_{peripheral edge}−ε_{centre}|>0.1 and ε_{peripheral edge}>1.5.

This patent application is the national phase entry of PCT/EP2024/051917, international application filing date Jan. 26, 2024, which claims the benefit and priority of and to German patent application no. 10 2023 102 085.4, filed Jan. 27, 2023.

### BACKGROUND OF THE INVENTION

The invention refers to a radiation unit.

It is known for example from US 2014 0176 377 A1 that a lens can be made of a solid dielectric material where holes are drilled into the material to impact the refractive index.

The material of the center of the lens has a relative permittivity of 2.04, where the outermost peripheral ring has a relative permittivity of 1.25. The shown lens has a relative permittivity at its edge of less than 1.5 and the deviation from center to edge differs by almost 0.02 from the given rule. There is at least one waveguide coupled to the lens in a way that electromagnetic radiation is transferred from the waveguide to the lens.

The cross-sectional size of the waveguide is inversely proportional to the square root of the dielectric permittivity of the material with which the waveguide is filled. By using a uniform material for coupling between the waveguide and the lens, the permittivity of the lens' material can be directly linked to the permittivity of the material the waveguide is filled with.

### SUMMARY OF THE INVENTION

It is an object of the invention to use a plurality of waveguides attached to a single lens to obtain an improved resolution and good focusing properties of the lens.

The object is solved by the characterizing features of the claims together with the preamble of the claims.

The subclaims are advantageous embodiments of the invention.

As commonly known in the prior art, the dielectric refractive lens body has a first relative permittivity ε_{centre} in the center and a second relative permittivity ε_{peripheral edge} in the edge region of the lens.

According to the invention, the permittivity is distributed over the lens body in a way that the first relative permittivity ε_{centre} and the second relative permittivity εperipheral edge fulfill the relation:

ε_{centre}=1.42 √ε_{peripheral edge}+0.58, allowing a tolerance band of 0.2, where |ε_{peripheral edge}−ε_{centre}|>0.1 and ε_{peripheral edge}>1,5.

Due to the tolerance band, the value of ε_{centre} fulfils the relation: 1.42 √ε_{peripheral edge}+0.78>ε_{centre}>1.42 ε_{peripheral edge}+0.38.

The edge permittivity above 1.5 allows for the coupling of a waveguide that is filled with a material having a relatively high relative permittivity, wherein the relative permittivity is preferably above 2.5 more preferably above 3, thus allowing for waveguides with a small cross-section. If the material according to the prior art were used, the increase of the edge permittivity would lead to a distribution of the relative permittivity inside the lens with which the focusing properties of the beams and, therefore, the gain would be reduced.

By applying the above relation, the lens provides a radiation unit that comprises a higher gain than a lens body with relative permittivity distribution significantly outside the relation of ε_{centre}=1.42 √ε_{peripheral edge} edge+0.58 for a chosen ε_{peripheral edge}.

According to this relation, in some cases the second relative permittivity ε_{peripheral edge} is smaller than the first relative permittivity ε_{centre} at the center, while in other cases it is the opposite.

It is the idea of the invention that the dielectric permittivity in the lens's edge region in transition to an attached waveguide is increased to match a relative permittivity of a substrate integrated waveguide whose relative permittivity is higher than 1.5 so that the reflections at their interface are kept low. As a result, a very good coupling from the lens to the waveguide is achieved so that losses are reduced, thereby achieving better radiation efficiency and hence power consumption can be reduced.

Due to the distribution of the dielectric permittivity according to the invention, the focusing properties of a classical Luneburg lens can almost be achieved with an ε_{peripheral edge}>1.5. Accordingly, an intrinsic connection to an attached waveguide can be achieved where the dielectric material within the waveguide has a permittivity that is higher or close to that of the ε_{peripheral edge}.

By increasing or decreasing the permittivity from ε_{peripheral edge} to ε_{centre}, the focusing properties of the lens according to the invention can be achieved that are close to the focusing properties of a classical Luneburg lens.

The dielectric permittivity distribution over the lens in its radial extension follows a square evolution. The radial position r is an element between [0.1], particularly the normalized radius of a sphere or a cylinder, where each point or position having a radial coordinate r has the relative permittivity following the relation:

$${ε}_{r} ( r ) = {ε}_{centre} - ( {ε}_{centre} - {ε}_{peripheral edge} ) {r}^{2} .$$

Accordingly, for a given ε_{peripheral edge} an ε_{centre} can be chosen that guarantees an optimal gain for the lens.

In a preferred embodiment, the distribution is staggered. This can result in a ring-like distribution, where, in particular, the rings are concentrically arranged. In a further preferred embodiment, the width of a ring is between 1/10^{th} and 1/15^{th} of the lens's radius.

One possible way to implement a staggered distribution is to introduce holes in the different rings constituting the lens. In each ring, the effective/equivalent dielectric permittivity is assumed to be the weighted average between that of the dielectric body ε_{diaelectricBody} and that of the material constituting the holes εₕₒₗₑₛ (anything, in particular air), where the weight given to both quantities is proportional to the percentage of each material in the ring:

$${ε}_{ring} = ( {V}_{holes} / {V}_{ring} ) {ε}_{holes} + ( ( {V}_{ring} - {V}_{holes} ) / {V}_{ring} ) {ε}_{dielectricBody}$$

$${ε}_{ring} = ( \% of holes material in the ring ) {ε}_{holes} + ( \% of dielectric body in the ring ) {ε}_{dielectricBody}$$

Another possible implementation is a randomized distribution of holes, which does not follow predefined rings/zones. In that case, the effective dielectric permittivity at a given point is considered to be the weighted average between that of the dielectric body ε_{diaelectric_body} and that of the material constituting the holes εₕₒₗₑₛ (anything, in particular air), where the weight given to both quantities is proportional to the percentage of each material in a cylindrical zone of a cylindrical lens (with an axis aligned with the axis of the cylindrical lens) of radius equal to a tenth of the lens radius, centered around the given point, and of a thickness covering exclusively the cylindrical lens thickness/height. A cylindrical lens can shape a fan shaped beam that allows for evaluating an echo along a band shaped section. A combination of two such lenses for transmitting and receiving can produce a grid.

Another possible implementation is a randomized distribution of holes, which does not follow predefined rings/zones. In that case, the effective dielectric permittivity at a given point is considered to be the weighted average between that of the dielectric body ε_{diaelectricBody} and that of the material constituting the holes εₕₒₗₑₛ (anything, in particular air), where the weight given to both quantities is proportional to the percentage of each material in a spherical zone (in the case of a spherical lens) of a radius equal to a tenth of the lens radius, centered around the given point.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs.

### BRIEF DESCRIPTION OF THE DRAWINGS

In the drawings is shown:

FIG. 1 a perspective view of a lens according to the invention;

FIG. 2 a curve of the relation ε_{peripheral edge} to ε_{centre} and

FIG. 3 a graphic illustration of the function εᵣ(r) for several ε_{centre}/ε_{edge} combinations.

### DESCRIPTION OF THE INVENTION

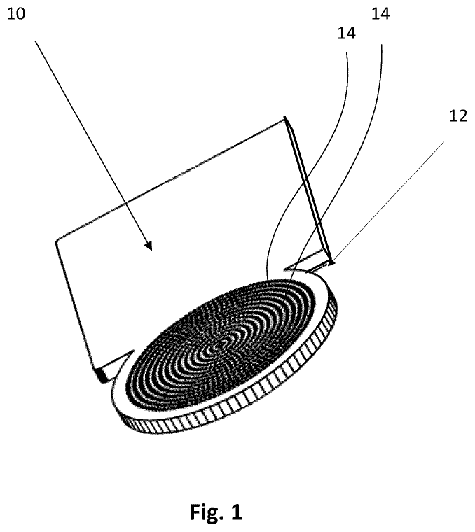

FIG. 1 shows a perspective view of a lens 10 according to the invention. The lens 10 of FIG. 1 can be part of a radiation unit. The lens 10 comprises a cylindrical dielectric body 12 that is covered by a metal layer on the top and the bottom side of the dielectric body. The lens 10 furthermore comprises holes 14, shown in black, that are drilled into the dielectric body 12. To ensure the effective/equivalent dielectric permittivity at the lens peripheral edge and at the lens's center the shape and the distribution of the holes 14 are chosen to meet the criteria ε_{centre}=1.42 √ε_{peripheral edge}+0.58, having a tolerance band of 0.2., where furthermore |ε_{peripheral edge}−ε_{centre}|>0.1 and ε_{peripheral edge}>1.5. The holes 14 do not necessarily need to have a circular cross-section. Accordingly, the value of ε_{centre} fulfils the relation: 1.42 √ε_{peripheral edge}+0.78>ε_{centre}>1.42 √ε_{peripheral edge}+0.38.

The dielectric permittivity distribution over the lens body 12 in its radial extension basically follows the function εᵣ (r)=ε_{centre}−(ε_{centre}−ε_{peripheral edge}) r²|r ϵ [0,1], where r is the normalized radial coordinate.

The distribution is staggered which leads to a ring like distribution of the dielectric permittivity, where the width of a ring is between 1/10^{th} and 1/15^{th} of the radius. In each ring, the effective/equivalent dielectric permittivity is assumed to be the weighted average between that of the dielectric body ε_{dielectricBody} and that of the material constituting the holes εₕₒₗₑₛ (anything, in particular air), where the weight given to both quantities is proportional to the percentage of each material in the ring:

$${ε}_{ring} = ( {V}_{holes} / {V}_{ring} ) {ε}_{holes} + ( ( {V}_{ring} - {V}_{holes} ) / {V}_{ring} ) {ε}_{dielectricBody}$$

$${ε}_{ring} = ( \% of holes material in the ring ) {ε}_{holes} + ( \% of dielectric body in the ring ) {ε}_{dielectricBody}$$

In this case, each ring comprises an equal width of 1 mm. The innermost zone, naturally, is a circle and not a ring.

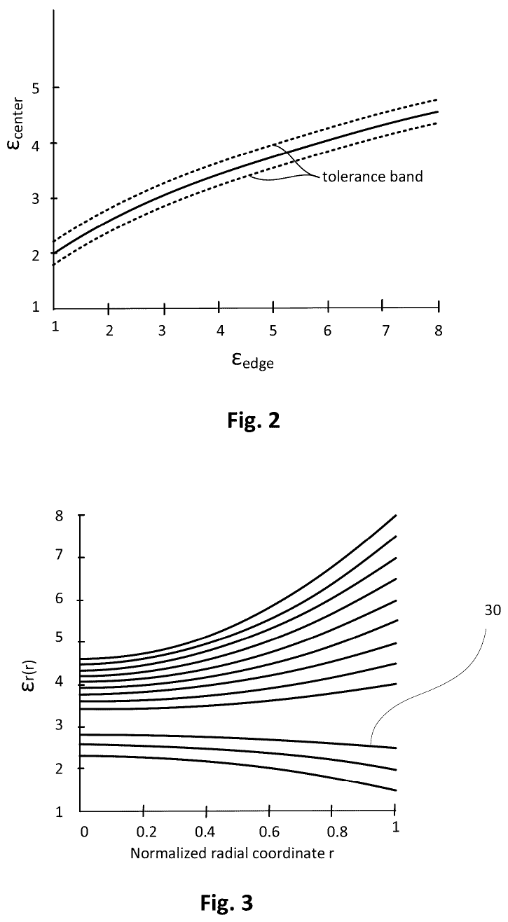

FIG. 2 shows a graph ε_{centre}=1.42 √ε_{peripheral edge}+0.58. The graph shows the optimal relation between a given edge permittivity ε_{peripheral edge} and the center permittivity ε_{centre}.

FIG. 3 shows the relation of ε_{f}(r)=ε_{centre}−(ε_{centre}−ε_{edge}) r² for several ε_{centre}/ε_{edge} combinations.

In this case, the graphs show a continuous distribution, but the distribution could also be implemented by zones, preferably of equal width, where the zones are defined in a way to approximately match the continuous distribution.

In this case the lowermost curve has a value of ε_{edge} which is close to that of air having a value of 1.5, where the ε_{centre}=2.3.

The distribution that is preferably used in this application, corresponds to an approximation of the shown ideal curve 30 which relates to a combination ε_{centre}=2.9 and ε_{edge}=2.6.

Having lenses correlating with this distribution, a lens can be chosen perfectly matched for the intended application, thereby providing optimal gain.

### LIST OF REFERENCE SIGNS

10 lens
12 dielectric lens body
14 holes
30 curve

1-5. (canceled)

6. A radiation unit comprising a lens (10) having a dielectric refractive lens body (12) that transfers electromagnetic waves, characterized in that the dielectric refractive lens body (12) has a first relative permittivity ε_{centre} in the center and a second relative permittivity ε_{peripheral edge} in the edge region of the lens, where the first relative permittivity ε_{centre} and the second relative permittivity ε_{peripheral edge} are related by the relation ε_{centre}=1.42 √ε_{peripheral edge}+0.58, with a tolerance of 0.2, where |ε_{peripheral edge}−ε_{centre}|>0.1 and ε_{peripheral edge}>1.5.

7. The radiation unit according to claim 6, characterized in that the lens (10) comprises at least two zones, where each zone comprises a point/position with a radial coordinate r corresponding to a relative permittivity value εᵣ(r), where εᵣ(r)=ε_{centre}−(ε_{centre}−ε_{peripheral edge})r².

8. The radiation unit according to claim 6, characterized in that the lens (10) is a gradient index lens whose permittivity successively increases or decreases from the first relative permittivity ε_{centre} to the second relative permittivity ε_{peripheral edge}.

9. The radiation unit according to claim 8, characterized in that the lens (10) is a generalized Luneburg lens.

10. The radiation unit according to claim 6, characterized in that that the dielectric refractive lens body (12) is of a solid dielectric material where the body comprises holes (14) to provide said permittivity distribution.
